(19) United States
(12) Patent Application Publication
(10) Pub. No.: US 2013/0136453 A1
(43) Pub. Date: May 30, 2013

(54) VISIBLE LIGHT COMMUNICATION METHOD AND VISIBLE LIGHT COMMUNICATION SYSTEM

(71) Applicants: Hideki Uema, Ginowan-shi (JP); Yuu Fukuhara, Ginowan-shi (JP); Hiroyoshi Ooshiro, Ginowan-shi (JP); Satoko Gibo, Ginowan-shi (JP)

(72) Inventors: Hideki Uema, Ginowan-shi (JP); Yuu Fukuhara, Ginowan-shi (JP); Hiroyoshi Ooshiro, Ginowan-shi (JP); Satoko Gibo, Ginowan-shi (JP)

(73) Assignee: MARINE COMMS RYUKYU, INC, Shimajiri-gun, Okinawa (JP)

(21) Appl. No.: 13/814,439

(22) PCT Filed: Jun. 18, 2012
(86) PCT No.: PCT/JP2012/065450

§ 371 Date: Feb. 5, 2013

(30) Foreign Application Priority Data
Jul. 7, 2011 (JP) 2011-151287

(51) Int. Cl. H04B 10/80

(52) U.S. Cl. CPC H04B 10/80
USPC 398/104

(57) ABSTRACT

A simple visible light communication method and system that, underwater in an ordinary water-quality in which a diver is allowed to go under the water, are able to reliably communicate with a ship, or the like, above water while the diver is stopping at a safety stop position at a depth of 5 m in order to prevent occurrence of dysbarism. The visible light communication method and system us the visible light communication system that includes a transmitter and a receiver and that is usable underwater, and include at a transmitting side, modulating information to be transmitted to pseudo-white light that is adjusted to have a color temperature of 4000 to 10000K and a luminous flux of 550 to 1500 lumens and that is emitted from an LED, and transmitting the pseudo-white light; and, at a receiving side, extracting the information by demodulating the received pseudo-white light.

### TECHNICAL FIELD

The present invention relates to a visible light communication method and visible light communication system that carry out data communication from underwater to underwater, from underwater to above water or from above water to underwater.

### BACKGROUND ART

Conventionally, there is a method that utilizes visible light in order to carry out data (information) communication underwater. There are disclosed methods and systems in which, in order to exchange data underwater, a transmitting side modulates data to be transmitted into visible light and transmits the visible light to underwater, and a receiving side receives the visible light and extracts information by demodulating the visible light (for example, Patent Document 1 to Patent Document 3).

### PRIOR ART DOCUMENT

### Patent Document

Patent Document 1: Japanese Patent Application Publication No. 4-312035
Patent Document 2: Japanese Patent Application Publication No. 2005-20422
Patent Document 3: Japanese Patent Application Publication No. 2008-304649

### SUMMARY OF THE INVENTION

### Problem to be Solved by the Invention

However, in the visible light communication methods and visible light communication systems that are implemented underwater by utilizing visible light, described in Patent Document 1 to Patent Document 3, there is a problem that communication between divers is based on the premise that these are used during normal times at close range of about 1 to 3 m and usage in an emergency is not assumed.

That is, if there occurs an accident of some kind while a diver is swimming or working in a deep underwater place, for example, at a depth of 20 m, even when the diver tries to surface in haste toward a ship, or the like, above water in order to immediately provide information about its situation, the diver needs to wait for about ten minutes at a safety stop position at a depth of about 5 m in order to prevent occurrence of dysbarism. At this time, even when the diver tries to make emergency contact with the use of the conventional close range visible light communication system, there is a problem that the emergency contact does not reach the ship, or the like, above water because a communicable range is short.

In order to solve the above-described problem, it is an object of the present invention to provide a simple visible light communication method and visible light communication system that allow not only divers to carry out communication underwater during normal times but also divers to reliably carry out communication from a safety stop position at a depth of about 5 m to a ship, or the like, above water in case of an emergency.

### Means for Solving the Problem

Then, the inventor found that extremely reliable and practical communication is possible in various environments underwater by adjusting the color temperature and luminous flux of visible light that is used in communication as a result of study about the band of the wavelength of visible light and the property of visible light underwater, and reached a solution of the above-described problem.

That is, the present invention as described in claim 1 provides a visible light communication method in which at least one of a transmitting side and a receiving side is present underwater. The visible light communication method includes: at the transmitting side, modulating information to be transmitted to pseudo-white light that is adjusted to have a color temperature of 4000 to 10000K and a luminous flux of 550 to 1500 lumens and that is emitted from an LED, and transmitting the pseudo-white light; and, at the receiving side, extracting the information by demodulating the received pseudo-white light.

The present invention as described in claim 2 provides a visible light communication system that includes a transmitter and a receiver and that is usable underwater, wherein the transmitter includes a light emitting unit in which an LED that emits pseudo-white light adjusted to have a color temperature of 4000 to 10000K and a luminous flux of 550 to 1500 lumens is arranged; and the receiver includes a light receiving unit that receives pseudo-white light that is emitted from the transmitter.

The present invention as described in claim 3 provides the visible light communication system described in claim 2, wherein the light emitting unit of the transmitter is also used as a light emitting unit of an underwater light.

### Effects of the Invention

With the visible light communication method or visible light communication system according to the present invention, by using pseudo-white light that is emitted from the LED adjusted to have a color temperature of 4000 to 10000K and a luminous flux of 550 to 1500 lumens, it is possible to ensure a communication range of 5 m or above underwater in an ordinary water-quality state (suspension state) in which a diver is allowed to go under the water. Thus, in an emergency, such as occurrence of an accident, by emitting light from underwater at a depth of 5 m, at which it is regarded as a safety stop position, toward a ship, or the like, above water, the light receiving unit provided underwater or above water receives the light. By so doing, it is possible to immediately carry out communication, such as a call for help.

When the light emitting unit of the visible light communication system according to the present invention is also used as a light emitting unit of an underwater light, the diver is not required to take an underwater light in addition to the transmitter according to the present invention at the time of diving, so it is convenient.

### BRIEF DESCRIPTION OF THE DRAWINGS

FIG. 1 is a block diagram that shows the configuration of a visible light communication system according to an embodiment of the present invention.

FIG. 2 is a view that illustrates a state where a diver wears the visible light communication system according to the embodiment of the present invention.

FIG. 3 is a view that illustrates another visible light communication system according to an embodiment of the present invention.

FIG. 4 is a view that illustrates an incident angle of a light receiving unit according to the embodiment of the present invention.

FIG. 5A and FIG. 5B are flowcharts of a visible light communication method according to an embodiment of the present invention.

FIG. 6 is a graph that shows the results obtained by testing a communication state between underwater and above water.

### MODES FOR CARRYING OUT THE INVENTION

Hereinafter, embodiments of the present invention will be described with reference to the accompanying drawings. The present invention is not limited to these embodiments without departing from the spirit of the present invention.

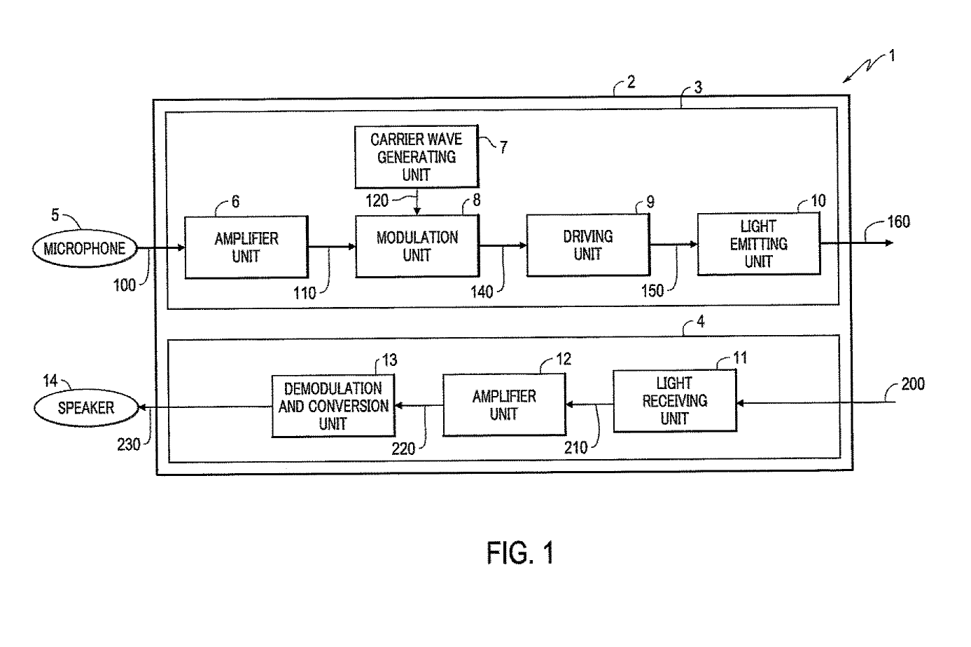

First, the configuration of a visible light communication system according to the present invention will be described with reference to FIG. 1.

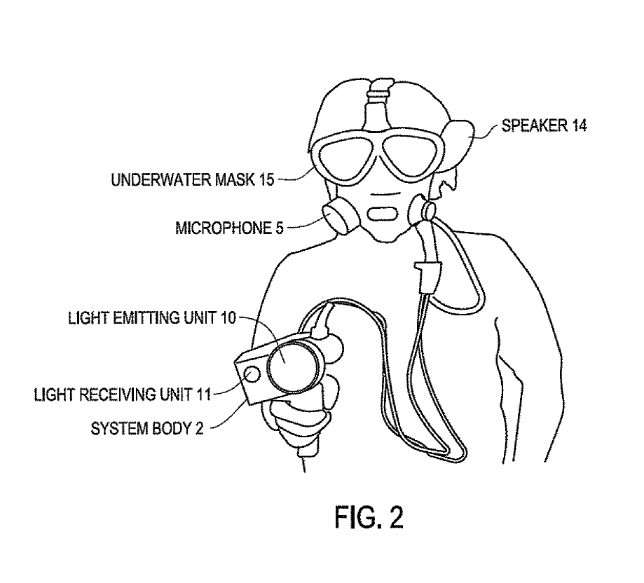

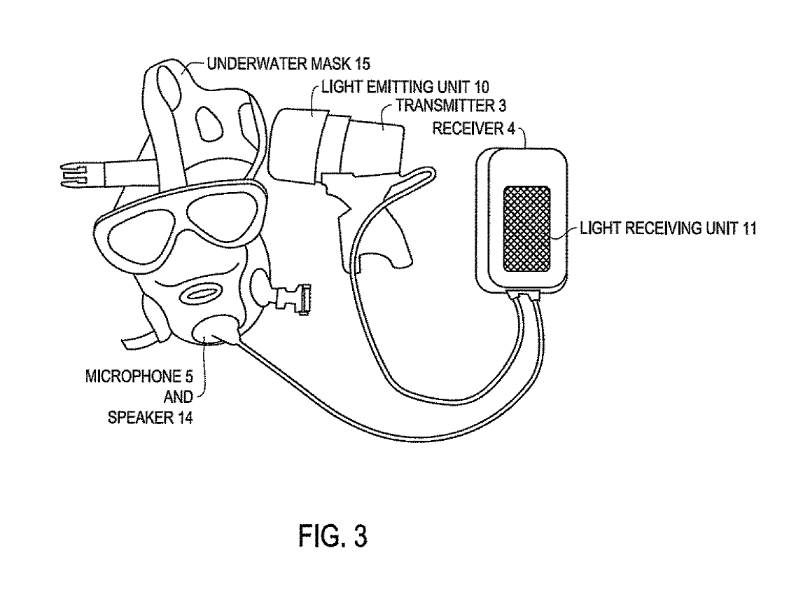

The visible light communication system 1 includes a system body 2, a microphone 5 and a speaker 14. The system body 2 includes a transmitter 3 and a receiver 4. In the present embodiment, as shown in FIG. 2, the system body 2 is formed in a shape in which a diver grips and uses the system body 2 with a hand; instead, the system body 2 may have another shape, for example, a shape in which a diver is allowed to wrap the system body 2 around an arm of the diver or attach the system body 2 to a chest of the diver. In the present embodiment, the microphone 5 and the speaker 14 are mounted in an underwater mask 15; instead, the microphone 5 may be separately mounted around a mouth of the diver, and the speaker 14 may be mounted in a headphone shape, or the like. As shown in FIG. 3, the transmitter 3 and the receiver 4 may be separately provided independent of each other.

The microphone 5 collects a sound produced by the diver, converts the sound to an electrical signal, and outputs the electrical signal. A piezoelectric type, or the like, may be used for the microphone 5.

The transmitter 3 is formed of an amplifier unit 6, a carrier wave generating unit 7, a modulation unit 8, a driving unit 9 and a light emitting unit 10. The amplifier unit 6 amplifies the electrical signal output from the microphone 5. The carrier wave generating unit 7 generates a carrier wave. The modulation unit 8 combines the electrical signal, amplified by the amplifier unit 6, with the carrier wave to generate transmission data, and modulates the transmission data. The driving unit 9 drives a light source. The light emitting unit 10 uses an LED as the light source.

For example, an analog signal, a digital signal, a pulse signal, or the like, may be selected as the carrier wave that is generated by the carrier wave generating unit 7. In view of the reliability, and the like, of communication, the pulse signal is desirably selected.

The modulation unit 8 combines the electrical signal, amplified by the amplifier unit 6, with the carrier wave to generate transmission data, and further modulates the transmission data. Analog modulation, digital modulation, pulse modulation, or the like, may be selected as a modulation mode.

The driving unit 9 causes the LED of the light source to emit light by flowing current based on, for example, a pulse-modulated pulse modulation signal, generated by the modulation unit 8, to the light emitting unit 10. For example, an analog signal, a digital signal, a pulse signal, or the like; may be selected as a driving waveform for driving the light source in the driving unit 9. When FM modulation processing is carried out in the modulation unit 8, it is possible to directly drive the LED of the light emitting unit 10, so the driving unit 9 may be omitted.

The light emitting unit 10 uses the LED as the light source. It is possible to blink the LED at high speed, so it is convenient in visible light communication. Visible light that is emitted from the light emitting unit 10 is pseudo-white light. Pseudo-white light may be, for example, generated by coloring a blue light emitting LED to yellow or covering a blue light emitting LED with a yellow filter. Alternatively, a pseudo-white LED that appropriately combines a blue light emitting LED with a green or red light emitting LED may be used.

The color temperature of pseudo-white light that is emitted from the LED of the light emitting unit 10 ranges from 4000K to 10000K, and more desirably ranges from 6000K to 10000K. When the color temperature is lower than 4000K, light takes on a strong yellow tinge, and a communication range underwater is short. When the color temperature exceeds 10000K, light takes on a strong blue tinge, so, when the transmitter is also used as an underwater light, an irradiated object may be seen as being different from an original color tone, and, therefore, it is not desirable.

A luminous flux of the pseudo-white light that is emitted from the LED (the brightness of all the rays of light emitted from the light source in a certain direction) ranges from 550 to 1500 lumens, and more desirably ranges from 550 to 1000 lumens. When the luminous flux is lower than 550 lumens, it is not the brightness suitable for communication. On the other hand, when the luminous flux exceeds 1000 lumens, it is felt extremely bright underwater, and, for example, when the luminous flux enters the eyes of a light-receiving-side diver in the case of communication between divers, an afterimage remains for a while and a vision during then decreases, so it is dangerous, and, in addition, when the transmitter is also used as an underwater light, an irradiated object may be seen as being different from its original color tone, so it is not desirable.

The color temperature of the pseudo-white light that is emitted from the LED may be adjusted by using a color temperature conversion filter or appropriately combining red and green light emitting LEDs with a blue light emitting LED. Alternatively, a luminous flux of the pseudo-white light that is emitted from the LED may be adjusted by changing the number of LEDs that are arranged in the light emitting unit 10 or replacing the LED with the one having different specifications.

The transmitter 3 may be used as an underwater light when visible light communication is not carried out. The pseudo-white light having a color temperature of 4000 to 10000K and a luminous flux of 550 to 1000 lumens is visible light suitable as an underwater light, and is able to clearly illuminate an underwater irradiated object with a natural cast.

The receiver 4 is formed of a light receiving unit 11, an amplifier unit 12 and a demodulation and conversion unit 13. The light receiving unit 11 receives pseudo-white light emitted from the LED of the light emitting unit 10, and outputs the pseudo-white light as an electrical signal. The amplifier unit 12 amplifies the electrical signal. The demodulation and conversion unit 13 demodulates and converts the electrical signal to a sound.

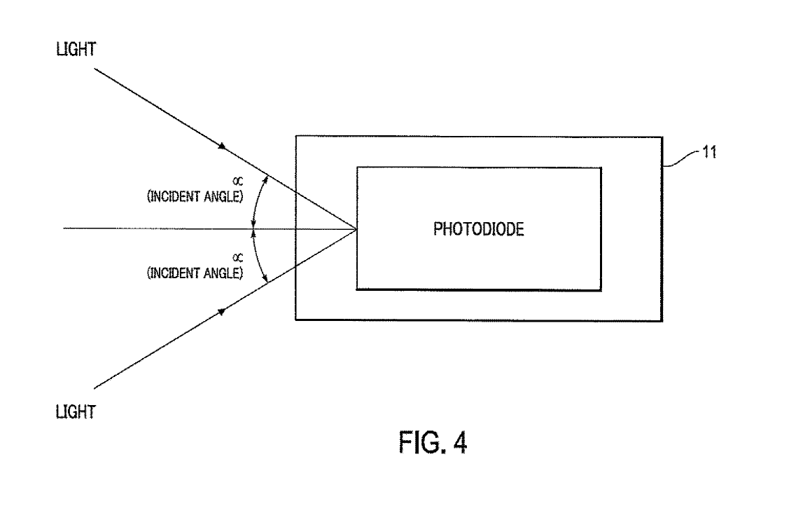

A photodiode is arranged in the light receiving unit 11 as a photoreceiver. An incident angle at which the photodiode is able to receive light is desirably 60° to 80° at the maximum. Here, the incident angle means an angle made between the incident direction of light and the normal to the light receiving face of the photodiode, and means an angle α shown in FIG. 4. When the receivable incident angle is smaller than 60°, the light receiving range of the light receiving unit 11 of the receiver 4 is narrow, so it is not possible to carry out communication unless the transmitting-side light emitting unit 10 and the receiving-side light receiving unit 11 are located to face each other with a considerable accuracy at the time of communication, and, therefore, it is inconvenient. On the other hand, when the receivable incident angle exceeds. 80°, outside light, such as sunlight, tends to enter the photodiode, so the output of the photodiode saturates and communication noise occurs, and, therefore, a receiver may hear a harsh sound.

The receivable incident angle of the photodiode may be adjusted by, for example, attaching a polarization filter to the light receiving unit 11 or appropriately casting a shadow by attaching a cover around the light receiving unit 11. In addition, there are a chip photodiode, a hermetically sealed photodiode, a shell photodiode, and the like. When the shell photodiode is used, communication noise due to incident outside light is generally hard to occur, so it is desirable.

The photodiode that is used in the present invention may have a light receiving sensitivity of 0.57 to 0.63 A/W, which is used to detect ordinary visible light. When the photodiode having a high light receiving sensitivity is used, every outside light is erroneously detected and communication noise tends to occur, so incident outside light just needs to be prevented as much as possible by attaching a polarization filter to the light receiving unit 11 or appropriately casting a shadow by attaching a cover to around the light receiving unit 11.

The demodulation and conversion unit 13 executes demodulation processing and analog sound processing. In the demodulation processing, a carrier frequency is removed from an electrical signal amplified by the amplifier unit 12. In the analog sound processing, the obtained signal is converted to an analog sound.

A throat speaker, a flesh vibration (flesh conduction) speaker, a headphone speaker, or the like, may be appropriately used as the speaker 14. However, because of the reason why the functions of an outer ear and ear drum decrease underwater due to water, a bone conduction speaker is desirably used in order to efficiently conduct a sound to an inner ear.

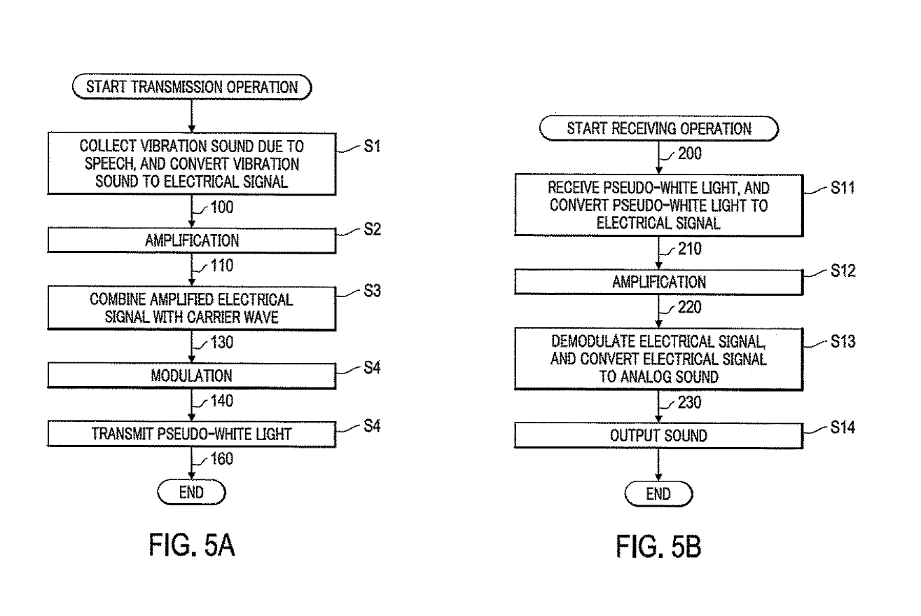

Next, a visible light communication method according to the present invention will be described with reference to the configuration of the system shown in FIG. 1 and the flowchart shown in FIG. 5A and FIG. 5B.

First, in a transmission operation shown in FIG. 5A, when a diver underwater speaks a message, the microphone 5 collects a vibration sound as a result of the speech, converts a vibration pattern of the vibration sound to an electrical signal 100, and then outputs the electrical signal 100 (step S1).

Subsequently, the amplifier unit 6 amplifies the electrical signal 100, and outputs an amplified electrical signal 110 (step S2). The carrier wave generating unit 7 generates a carrier wave (for example, pulse signal) 120. The modulation unit 8 combines the amplified electrical signal 110 with the carrier wave 120 to convert the amplified electrical signal 110 to transmission data 130 (step S3), and further generates modulated data 140 by modulating the transmission data (step S4).

The LED driving unit 9 flows a current 150, corresponding to the modulated data 140, through the light emitting unit 10. By so doing, the LED arranged in the light emitting unit 10 converts the modulated data 140 to a visible light signal 160, and blinks at high speed to transmit the visible light signal 160 (step S5). When an analog binary is used as a pulse wave in the carrier wave generating unit 7 and then FM modulation is carried out by shifting the position of the analog binary, the LED driving unit 9 may be omitted.

Subsequently, in a receiving operation shown in FIG. 5B, the photodiode arranged in the light receiving unit 11 receives a transmitted visible light signal 200, converts the visible light signal 200 to an electrical signal 210, and outputs the electrical signal 210 (step 11). The amplifier unit 12 outputs an amplified electrical signal 220 that is obtained by amplifying the electrical signal 210 (step S12). The demodulation and conversion unit 13 demodulates transmission data by removing the pulse wave from the amplified electrical signal 220, converts the demodulated transmission data to an analog sound 230 (step S13), and outputs the analog sound 230 to the speaker 14 (step S14).

As described above, with the use of the visible light communication method and visible light communication system according to the present embodiment, it is possible to ensure a communication range of 5 m or above underwater in an ordinary water-quality state (suspension state) in which a diver goes under the water. Thus, in an emergency, such as occurrence of an accident underwater, a diver emits light from underwater at a depth of 5 m, at which it is regarded as a safety stop position for preventing occurrence of dysbarism, toward a ship, or the like, above water, and the light receiving unit provided underwater or above water receives the light. By so doing, it is possible to immediately carry out communication, such as a call for help.

### EXAMPLES

### First Test Example

### Correlation Between Color Temperature and Communication Range

With the use of the visible light communication system 1 according to the present invention, the correlation between a color temperature and a communication range, appropriate for visible light communication, was examined by changing the color temperature of visible light that is emitted from the light emitting unit 10 among 4000K, 6000K and 8500K by using a color temperature conversion filter (for example, produced by FISHEYE, 30099, and the like). At this time, the luminous flux of visible light that is emitted from the light emitting unit 10 was set to 1000 lumens. An environment in which the test was conducted in seawater at a depth of 2 m, a turbidity of 0.41 FTU and a turbidity of 4.57 FTU, and the test was conducted by changing the light emitting unit-to-light receiving unit distance (horizontal distance) between the transmitting-side light emitting unit 10 and the receiving-side light receiving unit 11 from 4 to 30 m.

FIX LED 1000DX (produced by FISHEYE) was used as the light source of the light emitting unit 10. S6801 (produced by HAMAMATSU: a light receiving sensitivity of 0.57 to 0.63 A/W) was used as the photodiode of the light receiving unit 11. The turbidity of seawater was measured with the use of HI93703-B (produced by HANNA). A turbidity of 0.41 FTU is a state where the transparency in seawater is high, and a turbidity of 4.57 FTU is a state where sand, or the like, on the sea bottom is rolled up by tidal current and the water is cloudy; however, both are water-quality states where a diver is allowed to go under the water. The test results are shown in Table 1.

TABLE 1

| Distance | | | | | | | | | | | | |
|---|---|---|---|---|---|---|---|---|---|---|---|---|
| between | | | | | | | | | | | | |
| Light | | | | | | | | | | | | |
| Emitting | | | | | | | | | | | | |
| Unit and | Color Temperature (K) | | | | | | | | | | | |
| Light | 2500 | | 4000 | | 6000 | | 8500 | | 10000 | | 15000 | |
| Receiving | Turbidity (FTU) | | | | | | | | | | | |
| Unit (m) | 0.41 | 4.57 | 0.41 | 4.57 | 0.41 | 4.57 | 0.41 | 4.57 | 0.41 | 4.57 | 0.41 | 4.57 |
| 4 | B | C | A | A | A | A | A | A | A | A | D | D |
| 5 | C | C | A | A | A | A | A | A | A | A | D | D |
| 6 | C | C | A | A | A | A | A | A | A | A | D | D |
| 8 | C | C | B | B | A | A | A | A | A | A | D | D |
| 10 | C | C | B | B | A | B | A | B | A | A | D | D |
| 14 | C | C | B | B | B | B | A | B | A | A | D | D |
| 18 | C | C | B | C | B | B | A | B | A | A | D | D |
| 24 | C | C | C | C | B | B | B | B | A | B | D | D |
| 30 | C | C | C | C | B | B | B | B | A | B | D | D |

A: COMMUNICATION STATE IS GOOD
B: COMMUNICABLE BUT HAVING SLIGHT COMMUNICATION NOISE
C: NON-COMMUNICABLE
D: COMMUNICABLE BUT LIGHT TAKES ON STRONG BLUE TINGE AND IS NOT USABLE AS UNDERWATER LIGHT

It may be understood from Table 1 that, when the color temperature of visible light ranges from 4000 to 15000 K, it is possible to reliably carry out communication at a distance of 5 m which is required for emergency contact, in any of a situation that the turbidity of seawater is 0.41 FTU and a situation that the turbidity of seawater is 4.57 FTU. Furthermore, it may be understood that, when the color temperature of visible light ranges from 6000 to 15000K, it is possible to carry out communication at a distance of 30 m or longer in any of a situation that the turbidity of seawater is 0.41 FTU and a situation that the turbidity of seawater is 4.57 FTU. In addition, it may be understood that, when the color temperature of visible light is 15000K, it feels that light takes on a strong blue tinge.

### Second Test Example

### Correlation Between Luminous Flux and Communication Range

With the use of the visible light communication system 1 according to the present invention, the correlation between a luminous flux and a communication range, appropriate for visible light communication, was examined by adjusting the color temperature of visible light that is emitted from the light emitting unit 10 to 8500K by using a color temperature conversion filter (for example, produced by FISHEYE, 30099, and the like) and then changing the luminous flux among 250, 550, 1000 and 1500 lumens. An environment in which the test was conducted in seawater at a depth of 2 m, a turbidity of 0.41 FTU and a turbidity of 4.57 FTU, and the test was conducted by changing the light emitting unit-to-light receiving unit distance (horizontal distance) between the transmitting-side light emitting unit 10 and the receiving-side light receiving unit 11 from 4 to 30 m.

As the light source of the light emitting unit 10, UK NEW C4 eLED PLUS (produced by UNDERWATERKINETICS) was used for a light source having 250 lumens, LE550-S (produced by INON) was used for a light source having 550 lumens, FIX LED 1000DX (produced by FISHEYE) was used for a light source having 1000 lumens, and FIX LED 1000DX (produced by FISHEYE) was used for a light source having 1500 lumens. Then, the same one as that of the first test example was used for the photodiode of the light receiving unit 11, and the turbidity was also measured with the use of HI93703-B (produced by HANNA) as in the case of the first test example. The meaning of the turbidity is the same as that in the first test example, and both a turbidity of 0.41 FTU and a turbidity of 4.57 FTU are water-quality states where a diver is allowed to go under the water. The test results are shown in Table 2.

TABLE 2

| Distance | | | | | | | | |
|---|---|---|---|---|---|---|---|---|
| between | | | | | | | | |
| Light | | | | | | | | |
| Emitting | | | | | | | | |
| Unit and | Luminous Flux (lumen) | | | | | | | |
| Light | 250 | | 550 | | 1000 | | 1500 | |
| Receiving | Turbidity (FTU) | | | | | | | |
| Unit (m) | 0.41 | 4.57 | 0.41 | 4.57 | 0.41 | 4.57 | 0.41 | 4.57 |
| 4 | B | C | A | A | A | A | D | D |
| 5 | C | C | A | A | A | A | D | D |
| 6 | C | C | A | A | A | A | D | D |
| 8 | C | C | B | B | A | A | D | A |
| 10 | C | C | B | B | A | B | D | A |
| 14 | C | C | B | B | B | B | A | A |
| 18 | C | C | C | C | B | B | A | B |
| 24 | C | C | C | C | B | B | B | B |
| 30 | C | C | C | C | B | B | B | B |

A: COMMUNICATION STATE IS GOOD
B: COMMUNICABLE BUT HAVING SLIGHT COMMUNICATION NOISE
C: NON-COMMUNICABLE
D: COMMUNICATION STATE IS GOOD; HOWEVER, IT IS FELT EXTREMELY BRIGHT WHEN IT ENTERS EYES

It may be understood from Table 2 that, when the luminous flux of visible light ranges from 550 to 1500 lumens, it is possible to carry out communication at a distance of 14 m or longer in any of a situation that the turbidity of seawater is 0.41 FTU and a situation that the turbidity of seawater is 4.57 FTU. In addition, it may be understood that, when the luminous flux of visible light is 1500 lumens, a diver feels extremely bright within a close range, that is, within 10 m or within 6 m.

### Third Test Example

### Communication State Between Underwater and Above Water

With the use of the visible light communication system 1 according to the present invention, a bidirectional communication test was carried out between a diver under the sea at a depth of 5 m and a person on a ship. As for a positional relationship therebetween, the light emitting unit 10 and light receiving unit 11 of the system body 2, gripped by the diver under the sea, were oriented upward at a depth of about 5 m, and the light emitting unit 10 and light receiving unit 11 of the system body 2, gripped by the person on the ship, were oriented downward at about 0.5 m above the sea level substantially just above the system body 2 gripped by the diver.

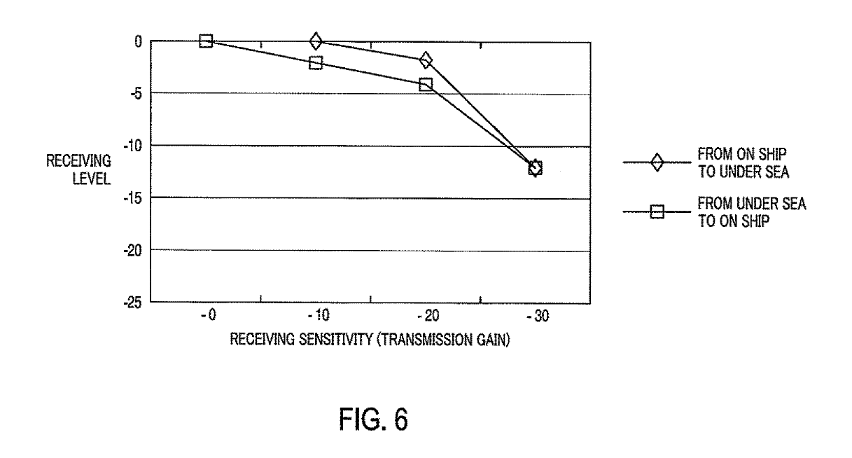

The color temperature of pseudo-white light that is emitted from each light emitting unit 10 was adjusted to 8500K with the use of the color temperature conversion filter (produced by FISHEYE, 30099), and the luminous fix was set to 1000 lumens. In addition, FIX LED 1000DX (produced by FISHEYE) was used for the light source of each light emitting unit 10. The turbidity of seawater was 0.41 FTU when measured with the use of HI93703-B (produced by HANNA) as in the case of the first test example and the second test example. The turbidity of 0.41 FTU is a state where the transparency in seawater is high. A graph of the test results is shown in FIG. 6.

It may be understood from FIG. 6 that, when light is transmitted from under the sea to on the ship (above the sea level) or when light is transmitted from on the ship (above the sea level) to under the sea, the light was received at a sufficiently receivable level of −12 dB at the receiving side even in a state where the transmitting-side transmission gain is considerably decreased to −30 dB. That is, with the visible light communication system according to the present invention, it is found that it is possible to carry out bidirectional communication in a favorable state between underwater at 4 depth of 5 m and above water.

### DESCRIPTION OF REFERENCE NUMERALS

1 VISIBLE LIGHT COMMUNICATION SYSTEM
2 SYSTEM BODY
3 TRANSMITTER
4 RECEIVER
5 MICROPHONE
14 SPEAKER

What is claimed is:

1. A visible light communication method in which at least one of a transmitting side and a receiving side is present underwater, comprising:
at the transmitting side, modulating information to be transmitted to pseudo-white light that is adjusted to have a color temperature of 4000 to 10000K and a luminous flux of 550 to 1500 lumens and that is emitted from an LED, and transmitting the pseudo-white light; and
at the receiving side, extracting the information by demodulating the received pseudo-white light.

2. A visible light communication system that is usable underwater, comprising:
a transmitter provided a light emitting unit in which an LED that emits pseudo-white light adjusted to have a color temperature of 4000 to 10000K and a luminous flux of 550 to 1500 lumens is arranged; and
a receiver provided a light receiving unit that receives a pseudo-white light that is emitted from the transmitter.

3. The visible light communication system according to claim 2, wherein the light emitting unit of the transmitter is also used as a light emitting unit of an underwater light.
